(19) United States
(12) Patent Application Publication
(10) Pub. No.: US 2006/0159812 A1
(43) Pub. Date: Jul. 20, 2006

(54) Method for making an alcoholic beverage

(76) Inventors: James Edward Goodwin, Jacksonville, FL (US); Andres Eduardo Del Rosal, Jacksonville, FL (US); Ricardo Henriquez, Panama City (PA); Gilberto Jasso Garcia, Arandas Jalisco (MX); Salvador Cervantes Lopez, Arandas Jalisco (MX)

Correspondence Address: JONES DAY, 222 EAST 41ST ST, NEW YORK, NY, 10017, US

(21) Appl. No.: 11/219,588

(22) Filed: Sep. 1, 2005

Related U.S. Application Data
(60) Provisional application No. 60/607,410, filed on Sep. 3, 2004.

(51) Int. Cl. C12H 1/04

(52) U.S. Cl. 426/330.4

(57) ABSTRACT

The present invention relates to methods for making an alcoholic beverage. In particular, the invention relates to methods for making an alcoholic beverage comprising distilling a first portion of an alcoholic mixture to provide a first distillate; distilling a second portion of the alcoholic mixture under conditions sufficient to provide a second distillate having a composition different from the first distillate; and admixing at least a portion of the first distillate and at least a portion of the second distillate to make a first blend. The first blend may optionally be aged, proof-adjusted, sparged with gas, and/or filtered to provide an alcoholic beverage. In one embodiment, the alcoholic beverage is tequila.

This application claims the benefit of U.S. provisional application No. 60/607,410, filed Sep. 3, 2004, the disclosure of the provisional application being incorporated by reference herein in its entirety.

### 1. FIELD OF THE INVENTION

The present invention relates to methods for making an alcoholic beverage, e.g., tequila, and the alcoholic beverage product of that method. In particular, the invention relates to methods for making an alcoholic beverage comprising distilling a first portion of an alcoholic mixture to provide a first distillate, distilling a second portion of the alcoholic mixture under conditions sufficient to provide a second distillate having a composition different from the first distillate, and admixing at least a portion of the first distillate and at least a portion of the second distillate to make a first blend.

### 2. BACKGROUND OF THE INVENTION

Premium alcoholic beverages are sought out by discerning consumers. For example, certain premium conventional tequilas are able to command retail prices of up to $300-$1,000 per bottle.

Processes for producing alcoholic beverages by a plurality of distillation steps conducted sequentially have long been known. For example, U.S. Pat. Nos. 4,985,264 to Clauzure, 5,356,641 to Bowen et al. and 6,506,430 B1 to Zimlich, III et al., and U.S. Published Patent Application No. 2002/0168446 A1 disclose a process comprising distillation of an alcoholic liquid followed by aging then at least one other distillation.

U.S. Pat. Nos. 2,207,111 to Rodenberg, 2,614,072 to Carlson et al., 2,892,757 to Markham and 4,784,868 to Young disclose a disclose a process comprising distillation of ethanol followed by at least one other distillation where the distillations are conducted sequentially.

Higashi U.S. Pat. No. 4,600,477 to Higashi et al. discloses a process in which a plant-derived fermented liquid is processed through a vacuum vaporizer and then through a multistage distillation column.

U.S. Pat. Nos. 5,458,739, 5,624,534 and 5,955,135, each to Boucher et al., disclose a process for the low-temperature stripping of volatiles, such as ethanol, from a feed stream to produce a lower ethanol product and, at the same time, increasing the ethanol in an overhead vapor, which is then condensed.

U.S. Pat. Nos. 347,441 to Ramsay, 2,946,687 to Jacobs, 4,882,177 to Dziondziak and 5,520,943 to Osajima et al. disclose dispensing a gas into an alcoholic liquid.

U.S. Published Patent Application No. 2003/0110951 A1 discloses the introduction of a sweetener to distilled alcohol, either before and/or after application of ultrasonic energy.

However, there remains a need for alcoholic beverages of premium quality, e.g., with superior nose, flavor and/or taste, and for methods of making the same.

The present invention addresses these needs in its methods for making alcoholic beverages by improved distillation methods and in the improved alcoholic beverages produced thereby. In the present invention, harsh elements from the distillate are removed and/or the taste of the alcoholic beverage is improved.

### 3. SUMMARY OF THE INVENTION

The present invention is directed to methods for making an alcoholic beverage by a distillation method. In one embodiment, the invention relates to a method for making an alcoholic beverage, comprising:

a) providing an alcoholic mixture, optionally aged;

b) distilling a first portion of the alcoholic mixture to provide a first distillate;

c) distilling a second portion of the alcoholic mixture under conditions sufficient to provide a second distillate having a composition different from the first distillate; and

d) admixing at least a portion of the first distillate and at least a portion of the second distillate to make a first blend.

In another embodiment, the first portion of the alcoholic mixture and the second portion of the alcoholic mixture are distilled substantially simultaneously.

The first blend may be aged, proof adjusted, sparged with gas, proof-adjusted and/or filtered to provide the alcoholic beverage.

In another embodiment, the invention relates to a method for making tequila.

In another embodiment, the invention relates to a first blend product of a method of the invention. In another embodiment, the invention relates to an alcoholic beverage comprising a first blend of the invention. In another embodiment, the invention relates to an aged second blend product of a method of the invention. In another embodiment, the invention relates to an alcoholic beverage comprising an aged second blend of the invention. In another embodiment, the invention relates to an alcoholic beverage comprising tequila.

In another embodiment, the present invention relates to a blended alcoholic beverage comprising at least one conventional distilled spirit and a first blend of the invention, an aged second blend of the invention, or any mixture thereof. In another embodiment, the present invention relates to a blended alcoholic beverage comprising at least one conventional wine and a first blend of the invention, an aged second blend of the invention, or any mixture thereof.

The present invention can be understood more fully by reference to the following figures, detailed description and examples, which are intended to exemplify non-limiting embodiments of the invention.

### 4. BRIEF DESCRIPTION OF THE DRAWINGS

FIG. 1A depicts an exemplary embodiment of the invention where an alcoholic mixture is distilled in a first distillation to provide a first distillate, and the light and heavy fractions of the first distillation are removed from the process.

FIG. 1B depicts an exemplary embodiment of the invention where an alcoholic mixture is distilled in a second distillation to provide a second distillate, and the light and heavy fractions of the second distillation are removed from the process.

FIG. 1C depicts an exemplary embodiment of the invention where a first portion of an alcoholic mixture is distilled in a first distillation to provide a first distillate, and, substantially simultaneously, a second portion of the alcoholic mixture is distilled in a second distillation to provide a second distillate. FIG. 1C also shows that the light and heavy fractions of the first and second distillation are removed from the process.

FIG. 2 depicts an exemplary embodiment of the invention where a first distillate and a second distillate are admixed, aged, proof-adjusted, rested, sparged, and filtered to provide an alcoholic beverage.

FIG. 3 depicts a known process for preparing tequila, e.g., conventional tequila blanco and conventional tequila reposado, from processed pinas by a process comprising fermenting the must, distilling the must to provide ordinary or conventional tequila having an alcohol content of about 31% by volume, distilling the conventional tequila, to provide a product having an alcohol content of about 63% by volume, proof adjusting the product to provide a product known as conventional tequila blanco, and optionally aging the tequila blanco to provide a product known as conventional tequila reposado.

FIG. 4 depicts an exemplary embodiment of the invention where a first portion of tequila is distilled in a first distillation to provide a first distillate; substantially simultaneously or simultaneously with the first distillation, a second portion of tequila is distilled in a second distillation to provide a second distillate; and the first and second distillate are admixed to provide a first blended tequila of the invention. FIG. 4 also shows that the light and heavy fractions of the first and second distillation are removed from the process.

FIG. 5 depicts an exemplary embodiment of the invention where the first blended tequila is further processed by proof-adjusting, resting, sparging with gas, filtering, and proof-adjusting to provide a first tequila of the invention. FIG. 5 also depicts another exemplary embodiment of the invention where the blended tequila is aged in a wooden vessel and then is further processed by proof-adjusting, resting, sparging with gas, filtering, and proof-adjusting to provide a second tequila of the invention.

### 5. DETAILED DESCRIPTION OF THE INVENTION

### 5.1 Methods for Making a First Blend

As noted above, the present invention is directed to methods for making an alcoholic beverage from a first blend. In one embodiment, the invention relates to a method for making an alcoholic beverage, comprising:

a) providing an alcoholic mixture, optionally aged;

b) distilling a first portion of the alcoholic mixture to provide a first distillate;

c) distilling a second portion of the alcoholic mixture under conditions sufficient to provide a second distillate having a composition different from the first distillate; and

d) admixing at least a portion of the first distillate and at least a portion of the second distillate to make a first blend.

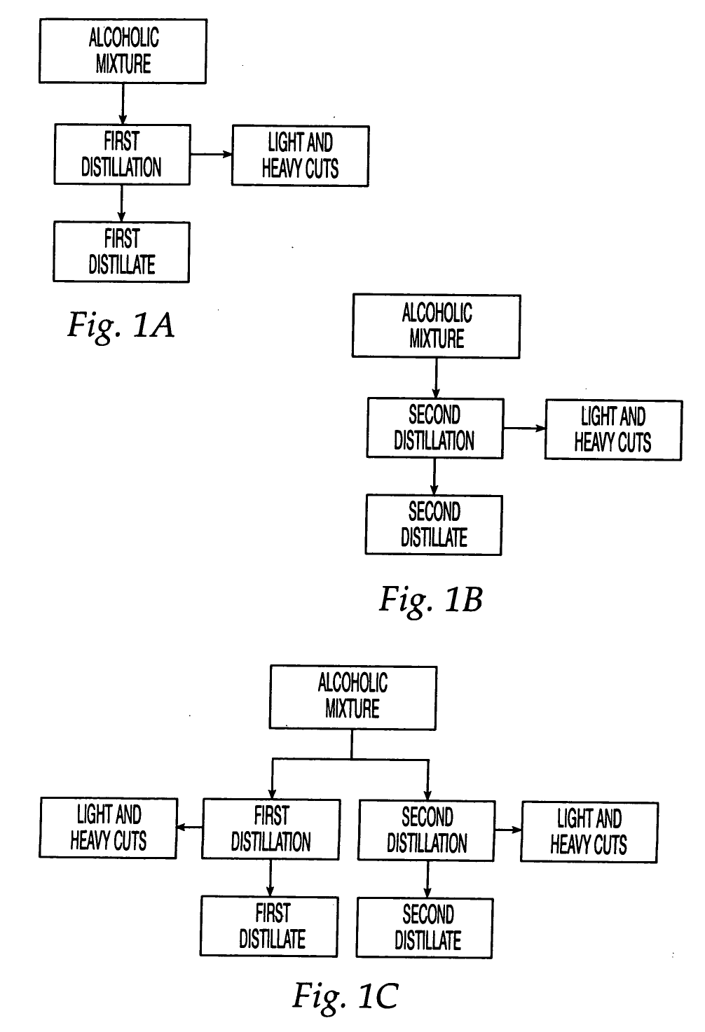

Referring to the figures, FIGS. 1A and 1B depict non-limiting embodiments of the invention for distilling the first distillate (FIG. 1A) and the second distillate (FIG. 1B), respectively. In one embodiment, the first distillation (FIG. 1A) is carried out before the second distillation (FIG. 1B) is carried out. In another embodiment, the second distillation (FIG. 1B) is carried out before the first distillation (FIG. 1A) is carried out. FIG. 1C depicts another non-limiting embodiment of the invention where the first distillation and the second distillation are carried out substantially simultaneously.

As used herein, the phrase “substantially simultaneously” when used in connection with the first and second distillations means that at least 25% of the second distillation occurs concurrently with the first distillation. As used herein, the phrase “simultaneously” when used in connection with the first and second distillations means that at least a majority of the second distillation, i.e., greater than 50%, occurs concurrently with the first distillation. In another embodiment, greater than 60% of the second distillation occurs concurrently with the first distillation. In another embodiment, greater than 73% of the second distillation occurs concurrently with the first distillation. In another embodiment, greater than 90% of the second distillation occurs concurrently with the first distillation. In another embodiment, greater than 94% of the second distillation occurs concurrently with the first distillation.

As shown in FIGS. 1A, 1B and 1C, the low temperature boiling fractions (i.e., high volatility) (“light cuts”) and high temperature boiling fraction (i.e., low volatility) (“heavy cuts”) are removed from the process. Without being limited by theory, it is thought that removing the low boiling and/or high boiling fractions from the alcoholic mixture improves the taste characteristics of the distillate.

As used herein, the phrase “alcoholic mixture” means a liquid composition comprising alcohol, i.e., ethanol, and a volatile portion such as water and, optionally, suspended solids. The liquid composition may be an admixture, such as a solution, a suspension, a dispersion, an emulsion, a microemulsion or the like.

Non-limiting examples of alcoholic mixtures useful in the present methods for making an alcoholic beverage include, for example, mashes prepared from fermented grains (such as corn, wheat, barley or rye) and alcoholic beverages derived from fermented grains, e.g., whiskey, bourbon, rye, vodka, gin and/or beer. Other non-limiting examples of alcoholic mixtures include those derived from fermented fruits, e.g., wine, brandy, sherry and cognac; fermented juices derived from sugar cane and/or sugar beets, e.g., rum; or fermented juices derived from the head of the agave tequilana weber, e.g., conventional tequila, conventional tequila blanco, conventional tequila reposado (aged in an oak barrel for at least 2 months), or conventional tequila ańejo (aged in an oak barrel for at least 12 months). It will be understood that the alcoholic mixture can be in any stage of refinement, such as a fermented mash, or an alcoholic beverage, e.g., a conventional tequila.

In one embodiment, the alcoholic mixture is derived from the fermented juices extracted from the head of the Agave Tequilana Weber, which is used to make tequila alcoholic beverages. In another embodiment, the alcoholic mixture comprises conventional tequila, conventional tequila blanco, conventional tequila reposado, conventional tequila ańejo, or any mixture thereof. In another embodiment, the alcoholic mixture consists essentially of conventional tequila, conventional tequila blanco, conventional tequila reposado, conventional tequila ańejo, or any mixture thereof. In another embodiment, the alcoholic mixture comprises conventional tequila. In another embodiment, the alcoholic mixture consists essentially of conventional tequila. In another embodiment, the alcoholic mixture is conventional tequila. In another embodiment, the alcoholic mixture comprises conventional tequila blanco. In another embodiment, the alcoholic mixture consists essentially of conventional tequila blanco. In another embodiment, the alcoholic mixture is conventional tequila blanco. In another embodiment, the alcoholic mixture comprises conventional tequila reposado. In another embodiment, the alcoholic mixture consists essentially of conventional tequila reposado. In another embodiment, the alcoholic mixture is conventional tequila reposado. In another embodiment, the alcoholic mixture comprises conventional tequila ańejo. In another embodiment, the alcoholic mixture consists essentially of conventional tequila ańejo. In another embodiment, the alcoholic mixture is conventional tequila ańejo.

As used herein, the phrase “volatile portion” means a component or a plurality of components that can be distilled from the alcoholic mixture under distillation conditions defined herein.

The first and second distillation provide the first and second distillates, respectively, and can be carried out by, e.g., flash distillation, reduced pressure distillation, and/or fractional distillation (see J. E. Bujake, “Beverage Spirits, Distilled,” in 4 Kirk-Othmer: Encyclopedia of Chemical Technology 153-183 (1993) and Perry's Chemical Engineer's Handbook 13.1-13.97 (1984), the entire contents of the aforementioned being incorporated herein by reference). In one embodiment, the first distillation is carried out at about atmospheric pressure. In another embodiment, the second distillation is carried out at about atmospheric pressure. In another embodiment, the first and second distillations are each carried out at about atmospheric pressure.

As noted above, the second distillation is carried out under conditions sufficient to provide a second distillate having a composition different from the first distillate. Non-limiting methods for providing a second distillate having a composition different from the first distillate include, e.g., carrying out the second distillation at a temperature; pressure; reflux ratio; temperature and pressure; temperature and reflux ratio; pressure and reflux ratio; or temperature, pressure and reflux ratio that is different from the first distillation.

In one embodiment, the first and/or second distillation is carried out by fractional distillation to provide a first distillate fraction and a second distillate fraction.

As used herein, the phrase “distillate fraction” refers to the combination of separate distillation “cuts” that are obtained during the distillation. It will be understood that the boiling points and compositions of the individual cuts included in the distillate fraction can vary.

In one embodiment, the first distillation is carried out at a temperature of from about 65° C. to about 100°C. In another embodiment, the first distillation is carried out at a temperature of from about 75° C. to about 100° C. In another embodiment, the first distillation is carried out at a temperature of from about 75° C. to about 98° C. In another embodiment, the first distillation is carried out at a temperature of from about 75° C. to about 95° C.

In one embodiment, the first distillation is carried out at a pressure of from about 0.5 atm to about 1.5 atm. In another embodiment, the first distillation is carried out at a pressure of from about 0.9 atm to about 1.1 atm. In another embodiment, the first distillation is carried out at a pressure of about 1 atm.

In one embodiment, the first distillation is carried out at a reflux ratio of from about 2% to about 98%. In another embodiment, the first distillation is carried out at a reflux ratio of from about 5% to about 95%.

In one embodiment, the second distillation is carried out at a temperature of from about 65° C. to about 100° C. In another embodiment, the second distillation is carried out at a temperature of from about 75° C. to about 95° C. In another embodiment, the second distillation is carried out at a temperature of from about 75° C. to about 90° C.

In one embodiment, the second distillation is carried out at a pressure of from about 0.5 atm to about 1.5 atm. In another embodiment, the second distillation is carried out at a pressure of from about 0.9 atm to about 1.1 atm. In another embodiment, the second distillation is carried out at a pressure of about 1 atm.

In one embodiment, the second distillation is carried out at a reflux ratio of from about 2% to about 98%. In another embodiment, the second distillation is carried out at a reflux ratio of from about 5% to about 95%.

The first and second distillations are each carried out with a column having at least about 1 theoretical stages or plates. In one embodiment, the first distillation is carried out with a column having at least about 2 theoretical stages. In another embodiment, the second distillation is carried out with a column having at least about 2 theoretical stages.

As noted above, the alcoholic mixture can optionally be aged before distillation. Methods for aging the alcoholic mixture include those described in Section 5.2 for aging the first blend to provide an aged second blend.

The first distillate and second distillate are then admixed to form a first blend. The blending can be carried out by any method known in the art. In one embodiment, the first blend is formed by an admixing method, non-limiting examples of which include stirring, rotating, shaking, pumping, or any combination thereof. In one embodiment, the admixing method is pumping.

The admixing step is carried out for a time and at a temperature sufficient to form a first blend. In one embodiment, the admixing is carried out at a temperature of from about 10° C. to about 40° C. In another embodiment, the admixing step is carried out at a temperature of from about 15° C. to about 30° C. In another embodiment, the admixing step is carried out at a temperature of from about 20° C. to about 27° C. In another embodiment, the admixing step is carried out at a temperature of about 25° C.

In one embodiment, the admixing is carried out for a time of from about 0.5 hours to about 2 hours. In another embodiment, the admixing is carried out for a time of about 1 hour.

If desired, a proof-adjusting agent (e.g., water, an alcoholic mixture) can be added to the first blend to provide a first proof-adjusted first blend. The proof-adjusting agent can be added to increase or decrease the alcohol content of the first blend. In one embodiment, the proof-adjusting agent is added to decrease the alcohol content of the first blend. In another embodiment, the proof-adjusting agent is added to increase the alcohol content of the first blend.

The amount of proof-adjusting agent added to the first blend can vary. In one embodiment, the proof-adjusting agent is added in an amount sufficient to provide an alcohol content after adjustment of from about 33% to about 50% alcohol by volume (“ABV”), based on the total volume of the first proof-adjusted first blend. In another embodiment, the proof-adjusting agent is added in an amount sufficient to provide an alcohol content of from about 40% to about 46% ABV based on the total volume of the first proof-adjusted first blend. In another embodiment, the proof-adjusting agent is added in an amount sufficient to provide an alcohol content of from about 43% to about 45% ABV based on the total volume of the first proof-adjusted first blend. In another embodiment, the proof-adjusting agent is added in an amount sufficient to provide an alcohol content of about 44% ABV based on the total volume of the first proof-adjusted first blend. In another embodiment, the proof-adjusting agent is added in an amount sufficient to provide an alcohol content of about 43% ABV based on the total volume of the first proof-adjusted first blend. In another embodiment, the proof-adjusting agent is added in an amount sufficient to provide an alcohol content of about 40% ABV based on the total volume of the first proof-adjusted first blend.

Non-limiting examples of proof-adjusting agents include flavorants, honey, water, including demineralized water and deionized water, ethanol, alcoholic mixtures, or any combination thereof. In one embodiment, the proof-adjusting agent is a flavorant, honey, demineralized water, an alcoholic mixture, or any combination thereof. In another embodiment, the proof-adjusting agent is honey, demineralized water, or any combination thereof. In another embodiment, the proof-adjusting agent is a flavorant. In another embodiment, the proof-adjusting agent is water. In another embodiment, the proof-adjusting agent is demineralized water.

After proof adjusting, the optionally-first proof-adjusted first blend can optionally be rested. As used herein, the term “resting” means that the blend is allowed to stand without the administration of any external admixing, cooling or heating. Without being limited by theory, it is thought that the resting step allows the contents of the blend to interact in a gradual, controlled manner and allows for certain components to dissolve and/or for certain components to precipitate.

In one embodiment, the resting step is carried out in an unlined stainless steel tank with a limited headspace and vented in a control manner to the atmosphere.

In one embodiment, the resting is carried out at a temperature of from about 10° C. to about 40° C. In another embodiment, the resting is carried out at a temperature of from about 15° C. to about 30° C. In another embodiment, the resting is carried out at a temperature of from about 20° C. to about 27° C. In another embodiment, the resting is carried out at a temperature of about 25° C.

In one embodiment, the resting is carried out for a time of from about 1 hour to about 72 hours. In another embodiment, the resting is carried out for a time of from about 12 hours to about 48 hours. In another embodiment, the resting is carried out for a time of about 24 hours.

The optionally-rested first blend can then optionally be sparged to provide a sparged first blend. The sparging can be carried out by methods known in the art, e.g., by passing a sparge gas through a porous frit into the first blend, where the porous frit is submerged beneath the surface of the first blend. Non-limiting examples of sparging methods useful in the present invention include bubbling the sparge gas through a porous frit, such as a sintered metal, sintered glass or sintered ceramic porous frit, or an open-ended pipe, each immersed in the first blend. In one embodiment, the porous frit is a sintered metal frit.

In another embodiment, the sparging is carried out by further allowing the first blend to admix in a vessel with sufficient volume to provide a head space above the first blend, and sweeping the head space with the sparge gas.

The sparging of the first blend is carried out, in one embodiment, at a temperature of from about 10° C. to about 40° C. In another embodiment, the sparging of the first blend is carried out at a temperature of from about 15° C. to about 30° C. In another embodiment, the sparging of the first blend is carried out at a temperature of from about 20° C. to about 27° C. In another embodiment, the sparging of the first blend is carried out at a temperature of about 25° C.

In one embodiment, the sparging of the first blend is carried out for a time of at least about 1 hour. In another embodiment, the sparging of the first blend is carried out for a time of from about 1 hour to about 12 hours. In another embodiment, the sparging is carried out for a time of from about 4 hours to about 10 hours. In another embodiment, the sparging is carried out for a time of about 9 hours. In another embodiment, the sparging is carried out for a time of about 4.5 hours.

Non-limiting examples of sparge gases include air, nitrogen, oxygen, helium, neon, argon, krypton, carbon dioxide, or any combination of two or more of the foregoing. Compressed, clear, oil-free sparge gases are available from, e.g., Matheson Tri-Gas, Montgomeryville, Pa. The sparge gas is optionally passed through a charcoal filter before passing it into the first blend.

In one embodiment, the sparging is carried out using air as the sparge gas. In another embodiment, the sparging is carried out by passing air through a sintered metal porous frit immersed in the first blend, collecting the air in the head space above the first blend being sparged, and venting the air to atmosphere.

The progress of the sparging step can be monitored qualitatively, e.g., organoleptically, such by as taste and/or smell, and/or quantitatively using standard analytical methods such as gas chromatography, liquid chromatography, infrared spectroscopy, and/or mass spectroscopy.

Thereafter, the optionally-sparged first blend can optionally be filtered to provide a filtered first blend. The filtering can be done using conventional filtering methods and with conventional filtering media that are substantially inert relative to the first blend (see Ladislav Savorsky, “Filtration,” in 10 Kirk-Othmer: Encyclopedia of Chemical Technology 788-853 (1993) and Perry's Chemical Engineer's Handbook 19.65-19.89 (1984), the entire contents of each of the aforementioned reference being incorporated herein by reference). Non-limiting methods of filtering in the present invention include cartridge filtration, plate and frame filtration, pressure leaf filtration, and any combination of two or more of the foregoing. In one embodiment, the filtration method is plate and frame filtration.

Non-limiting examples of filtering medium include, e.g., porous metal, sintered glass, sintered plastic, fabric, pleated fabric, cellulose fabric, diatomaceous earth, or any combination thereof. In one embodiment, the filtering medium comprises cellulose fabric. In another embodiment, the filtering medium comprises diatomaceous earth. In another embodiment, the filtering medium comprises a slurry of diatomaceous earth on a stainless steel screen. In another embodiment, the filtering medium comprises a pad comprising diatomaceous earth and cellulose fabric. In another embodiment, the filtering medium is a pad comprising diatomaceous earth and cellulose fiber. Typically, the pad comprising diatomaceous earth and cellulose fiber is formed from an aqueous slurry of the diatomaceous earth and cellulose fiber. In a preferred embodiment, the filtration is carried with a plate and frame filter using a filtering medium comprising a pad comprising diatomaceous earth and cellulose fibers.

Porous metal filters are available from Mott Corporation, Farmington, Ct. Pleated fabric filters include Poly-Fine® filters, which are available from the Pall Corporation, East Hills, N.Y. Cellulose fabric is available from Seitz Filter Werke, Bad Krauznack, Germany. Diatomaceous earth is available from World Minerals, Lompoc, Calif.

In one embodiment, the filtering medium is a cellulose fabric having a mean pore diameter of from about 0.2 μm to about 5 μm. In another embodiment, the filtering medium is a cellulose fabric having a mean pore diameter of about 0.45 μm.

In certain embodiments, the filtering medium further comprises a filter aid. Non-limiting examples of filter aids include diatomaceous earth, expanded pearlite, cellulosic powder, or any mixture thereof.

Thereafter, the first blend can optionally be proof-adjusted to provide a second proof-adjusted first blend. Proof-adjusting agents useful for making a second proof-adjusted first blend include those described above for making the first proof-adjusted first blend. In one embodiment, the proof-adjusting agent is water. In another embodiment, the proof-adjusting agent is demineralized water. The amount of proof-adjusting agent added to the first blend can vary. In one embodiment, the proof-adjusting agent is added in an amount sufficient to provide an alcohol content after adjustment of from about 33% to about 50% ABV, based on the total volume of the second proof-adjusted first blend. In another embodiment, the proof-adjusting agent is added in an amount sufficient to provide an alcohol content after adjustment of from about 37% to about 44% ABV, based on the total volume of the second proof-adjusted first blend. In another embodiment, the proof-adjusting agent is added in an amount sufficient to provide an alcohol content after adjustment of from about 35% to about 43% ABV, based on the total volume of the second proof-adjusted first blend. In another embodiment, the proof-adjusting agent is added in an amount sufficient to provide an alcohol content after adjustment of from about 35% to about 40% ABV, based on the total volume of the second proof-adjusted first blend. In another embodiment, the proof-adjusting agent is added in an amount sufficient to provide an alcohol content of from about 37% to about 40% ABV based on the total volume of the second proof-adjusted first blend. In another embodiment, the proof-adjusting agent is added in an amount sufficient to provide an alcohol content of about 43% ABV based on the total volume of the second proof-adjusted first blend. In another embodiment, the proof-adjusting agent is added in an amount sufficient to provide an alcohol content of about 40% ABV based on the total volume of the second proof-adjusted first blend. In another embodiment, the proof-adjusting agent is added in an amount sufficient to provide an alcohol content of about 37.5% ABV based on the total volume of the second proof-adjusted first blend.

After optional second proof adjustment, the first blend can be packaged, e.g., bottled, to provide an alcoholic beverage, or optionally, further refined, e.g., by blending with proof-adjusting agent, blending with another beverage, and/or aging in a wooden vessel. In one embodiment, the invention relates to an alcoholic beverage comprising the first blend produced by any of the above-described methods.

### 5.2 Methods for Making an Aged Second Blend

The present invention also relates to methods for making an alcoholic beverage by aging the optionally-filtered first blend described in Section 5.1 to provide an aged second blend.

In one embodiment, the aging is carried out in a wooden vessel. Examples of wooden vessels for aging the second blend include those that impart a desirable color, flavor and/or aroma to the aged second blend. In another embodiment, the aging, when used, is carried out in a seasoned wooden vessel, preferably a seasoned oak barrel such as the barrels described in U.S. Pat. Nos. 5,356,641 and 6,506,430 B1, in U.S. Published Patent Application Nos. 2002/0137949 A1 and 2002/0168446 A1, and in J. E. Bujake, “Beverage Spirits, Distilled,” in 4 Kirk-Othmer: Encyclopedia of Chemical Technology 172-174 (1993). In another embodiment, the aging, when used, is carried out using roasted wood particles, such as those disclosed in U.S. Pat. No. 6,203,836 B1 to Gross, II. et al.

Typically, the seasoned oak barrel is charred on the inside. The charred oak barrel can be a virgin oak barrel, i.e., an oak barrel that has not previously been used to age an alcoholic mixture. Alternatively, a charred oak barrel used previously to age an alcoholic mixture, e.g., a conventional tequila, can be used. In one embodiment, the oak barrel is lightly charred. In another embodiment, the oak barrel is heavily charred. In another embodiment, the aging is carried out in a lightly charred oak barrel followed by aging in a heavily charred oak barrel. In another embodiment, a portion of the first blend is aged in a lightly charred oak barrel and another portion of the first blend is aged in a heavily charred oak barrel. In another embodiment, a portion of the first blend is aged in a lightly charred virgin oak barrel, another portion of the first blend is aged in a lightly charred oak barrel previously used to age an alcoholic mixture, and another portion of the first blend is aged in a heavily charred virgin oak barrel. In another embodiment, a portion of the first blend is aged in a lightly charred virgin oak barrel, another portion of the first blend is aged in a lightly charred oak barrel previously used to age an alcoholic mixture, and another portion of the first blend is aged in a heavily charred oak barrel previously used to age an alcoholic mixture. In another embodiment, a portion of the first blend is aged in a lightly charred virgin oak barrel, another portion of the first blend is aged in a lightly charred oak barrel previously used to age an alcoholic mixture, another portion of the first blend is aged in a heavily charred virgin oak barrel, and another portion of the first blend is aged in a heavily charred oak barrel previously used to age an alcoholic mixture. In another embodiment, a portion of the first blend is aged in a lightly charred virgin oak barrel, another portion of the first blend is aged in a heavily charred virgin oak barrel, and another portion of the first blend is aged in a heavily charred oak barrel previously used to age an alcoholic mixture. In another embodiment, a portion of the first blend is aged a lightly charred oak barrel previously used to age an alcoholic mixture, another portion of the first blend is aged in a heavily charred virgin oak barrel, and another portion of the first blend is aged in a heavily charred oak barrel previously used to age an alcoholic mixture.

The time and temperature of the aging step can vary. In one embodiment, the aging is carried out for a time of at least about 2 months. In another embodiment, the aging is carried out for a time of at least 2 months. In another embodiment, the aging is carried out for a time of 2 months. In another embodiment, the aging is carried out for a time of at least about 12 months. In another embodiment, the aging is carried out for a time of at least 12 months. In another embodiment, the aging is carried out for a time of 12 months. In another embodiment, the aging is carried out for a time of at least about 10 years. In another embodiment, the aging is carried out for a time of from 2 months to about 6 months. In another embodiment, the aging is carried out for a time of from 2 months to about 12 months. In another embodiment, the aging is carried out for a time of from 2 months to about 10 years.

In one embodiment, the aging is carried out at a temperature of from about 10° C. to about 40° C. In another embodiment, the aging is carried out at a temperature of from about 15° C. to about 30° C. In another embodiment, the aging is carried out at a temperature of from about 20° C. to about 27° C. In another embodiment, the aging is carried out at a temperature of about 25° C.

In certain embodiments, the first blend is diluted with a proof-adjusting agent before carrying out the aging step to provide a diluted first blend. Methods for diluting include those described in Section 5.1 in connection with proof adjusting the first blend. Typically, the proof-adjusting agent is water. In one embodiment, the proof-adjusting agent is demineralized water. In one embodiment, the proof-adjusting agent is added as required in an amount sufficient to provide a diluted first blend with an alcohol content of from about 43% to about 60% ABV based on the total volume of the diluted first blend. In another embodiment, the proof-adjusting agent is added as required in an amount sufficient to provide an alcohol content of from about 50% to about 60% ABV based on the total volume of the diluted first blend. In another embodiment, the proof-adjusting agent is added as required in an amount sufficient to provide an alcohol content of from about 53% to about 59% ABV based on the total volume of the diluted first blend. In another embodiment, the proof-adjusting agent is added as required in an amount sufficient to provide an alcohol content of from about 55% to about 59% ABV based on the total volume of the diluted first blend. In another embodiment, the proof-adjusting agent is added as required in an amount sufficient to provide an alcohol content of about 57% ABV based on the total volume of the diluted first blend.

After aging, the aged second blend can optionally be proof-adjusted by adding a proof-adjusting agent to form a first proof-adjusted second blend. Methods for proof adjusting the aged second blend include those described in Section 5.1 in connection with proof adjusting the first blend. As noted therein, the proof-adjusting agent can be added to increase or decrease the alcohol content of the aged second blend. In one embodiment, the proof-adjusting agent is added to decrease the alcohol content of the aged second blend. In another embodiment, the proof-adjusting agent is added to increase the alcohol content of the aged second blend.

The amount of proof-adjusting agent added to the aged second blend can vary. In one embodiment, the proof-adjusting agent is added in an amount sufficient to provide an alcohol content of from about 33% to about 50% ABV based on the total volume of the first proof-adjusted second blend. In another embodiment, the proof-adjusting agent is added in an amount sufficient to provide an alcohol content of from about 40% to about 46% ABV based on the total volume of the first proof-adjusted second blend. In another embodiment, the proof-adjusting agent is added in an amount sufficient to provide an alcohol content of from about 43% to about 45% ABV based on the total volume of the first proof-adjusted second blend. In another embodiment, the proof-adjusting agent is added in an amount sufficient to provide an alcohol content of about 44% ABV based on the total volume of the first proof-adjusted second blend. In another embodiment, the proof-adjusting agent is added in an amount sufficient to provide an alcohol content of about 43% ABV based on the total volume of the first proof-adjusted second blend. In another embodiment, the proof-adjusting agent is added in an amount sufficient to provide an alcohol content of about 40% ABV based on the total volume of the first proof-adjusted second blend.

Non-limiting examples of proof-adjusting agents useful for proof-adjusting the second blend include those described in Section 5.1 for proof-adjusting the first blend. In one embodiment, the proof-adjusting agent is a flavorant, honey, demineralized water, an alcoholic mixture, or any combination thereof. In another embodiment, the proof-adjusting agent is any admixture of honey and demineralized water.

Thereafter, the second blend can optionally be rested to form a rested second blend. In one embodiment, the resting is carried out at a temperature of from about 10° C. to about 40° C. In another embodiment, the resting is carried out at a temperature of from about 15° C. to about 30° C. In another embodiment, the resting is carried out at a temperature of from about 20° C. to about 27° C. In another embodiment, the resting is carried out at a temperature of about 25° C.

In another embodiment, the resting is carried out for a time of from about 20 hours to about 72 hours. In another embodiment, the resting is carried out for a time of from about 20 hours to about 48 hours. In another embodiment, the resting is carried out for a time of about 24 hours.

The second blend can optionally be sparged to form a sparged second blend. Methods for sparging the second blend include those described in Section 5.1 in connection with sparging the first blend. In one embodiment, the sparging of the second blend is carried out using air as the sparge gas. In another embodiment, the sparging is carried out by passing air through a sintered metal porous frit immersed in the aged second blend, collecting the air in the head space above the second blend being sparged, and venting to atmosphere.

In one embodiment, the sparging of the second blend is carried out at a temperature of from about 10° C. to about 40° C. In another embodiment, the sparging of the second blend is carried out at a temperature of from about 15° C. to about 30° C. In another embodiment, the sparging of the second blend is carried out at a temperature of from about 20° C. to about 27° C. In another embodiment, the sparging of the second blend is carried out at a temperature of about 25° C.

In one embodiment, the sparging of the second blend is carried out for a time of at least about 1 hour. In another embodiment, the sparging of the second blend is carried out for a time of from about 1 hour to about 12 hours. In another embodiment, the sparging is carried out for a time of from about 4 hours to about 10 hours. In another embodiment, the sparging of the second blend is carried out for a time of about 9 hours. In another embodiment, the sparging of the second blend is carried out for a time of 4.5 hours.

The second blend can then optionally be filtered to provide a filtered second blend. Methods and media for filtering the second blend include those described in Section 5.1 in connection with filtering the first blend. In one embodiment, the filtering medium is a cellulose fabric having a mean pore diameter of from about 0.2 μm to about 5 μm. In another embodiment, the filtering medium is a cellulose fabric having a mean pore diameter of about 0.5 μm.

After optional filtering, the second blend can optionally be proof-adjusted with a proof-adjusting agent to provide a second proof-adjusted second blend. Proof-adjusting agents useful for making a second proof-adjusted second blend include those described above for making the first proof-adjusted first blend. In one embodiment, the proof-adjusting agent is water. In another embodiment, the proof-adjusting agent is demineralized water. In another embodiment, the proof-adjusting agent is any admixture of honey and demineralized water. The amount of proof-adjusting agent added to the first blend can vary. In one embodiment, the proof-adjusting agent is added in an amount sufficient to provide an alcohol content of from about 33% to about 50% ABV based on the total volume of the second proof-adjusted second blend. In another embodiment, the proof-adjusting agent is added in an amount sufficient to provide an alcohol content of from about 37% to about 44% ABV based on the total volume of the second proof-adjusted second blend. In another embodiment, the proof-adjusting agent is added in an amount sufficient to provide an alcohol content of from about 38% to about 43% ABV based on the total volume of the second proof-adjusted second blend. In another embodiment, the proof-adjusting agent is added in an amount sufficient to provide an alcohol content of from about 35% to about 40% ABV based on the total volume of the second proof-adjusted second blend. In another embodiment, the proof-adjusting agent is added in an amount sufficient to provide an alcohol content of from about 37% to about 40% ABV based on the total volume of the second proof-adjusted second blend. In another embodiment, the proof-adjusting agent is added in an amount sufficient to provide an alcohol content of about 43% ABV based on the total volume of the second proof-adjusted second blend. In another embodiment, the proof-adjusting agent is added in an amount sufficient to provide an alcohol content of about 40% ABV based on the total volume of the second proof-adjusted second blend. In another embodiment, the proof-adjusting agent is added in an amount sufficient to provide an alcohol content of about 37.5% ABV based on the total volume of the second proof-adjusted second blend.

In one embodiment, the proof-adjusting agent is a flavorant, honey, demineralized water, an alcoholic mixture, or any combination thereof. In another embodiment, the proof-adjusting agent is any admixture of honey and demineralized water, and the proof-adjusting agent is added in an amount sufficient to provide a second proof-adjusted second blend having an alcohol content of about 40% ABV and a honey content of about 4 to about 8 g/liter.

After optional second proof-adjustment, the second blend can be packaged, e.g., bottled, to provide an alcoholic beverage, or optionally, further refined, e.g., by blending with proof-adjusting agent, blending with another beverage, and/or aging in a wooden vessel as described above. In one embodiment, the invention relates to an alcoholic beverage comprising the second blend produced by any of the above-described methods. In another embodiment, the invention relates to an alcoholic beverage comprising the first blend and the second blend produced by any of the above-described methods.

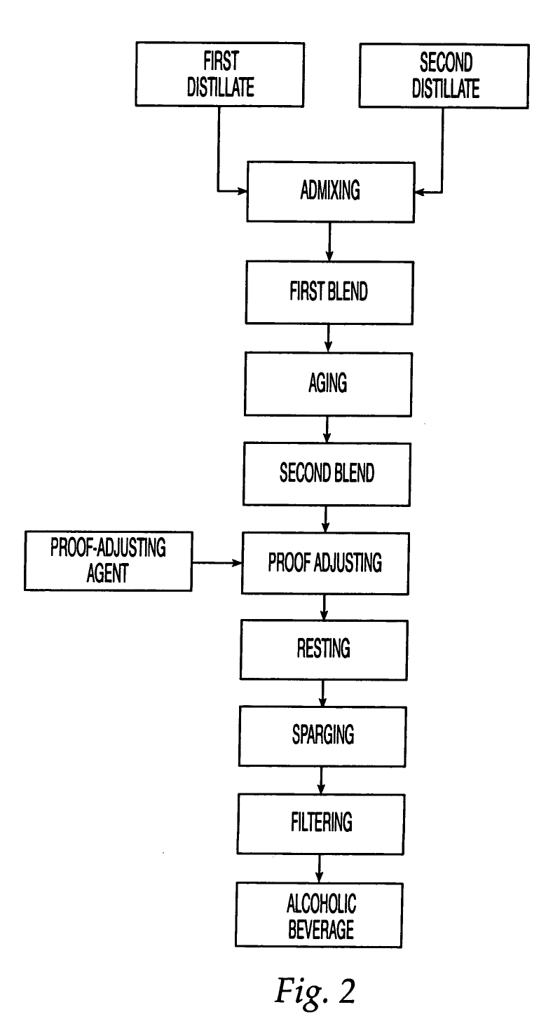

Referring to the figures, FIG. 2 exemplifies an embodiment of the invention where an alcoholic beverage is prepared by blending a first distillate and a second distillate to provide a first blend. As depicted in FIG. 2, the first blend undergoes aging to provide a second blend, and the second blend thereafter undergoes proof adjusting with a proof-adjusting agent, resting, sparging, and filtering to form a proof-adjusted first blend. After proof-adjusting the, proof-adjusted first blend is filtered to provide an alcoholic beverage.

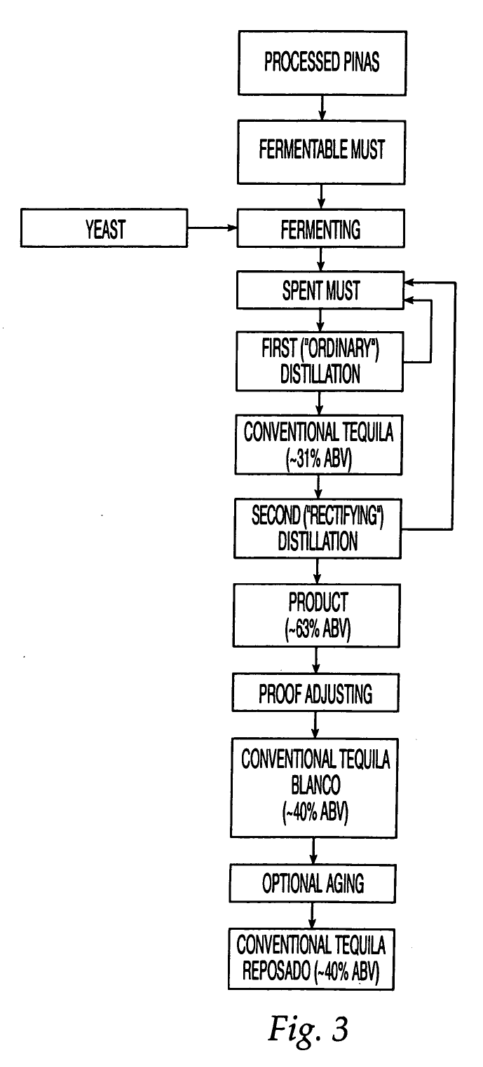

FIG. 3 depicts a conventional process for preparing tequila from processed pinas, e.g., as disclosed in U.S. Published Patent Application No. 2002/0119217 A1; J. E. Bujake, “Beverage Spirits, Distilled,” in 4 Kirk-Othmer: Encyclopedia of Chemical Technology 165-166 (1993); and “History and Process [of Tequila]” at www.camaratequilera.com.mx /ingles/history.htm. As shown in FIG. 3, processed pinas are converted into a fermentable must. The fermentable must is contacted with yeast and allowed to ferment, and the resultant fermented must is distilled (first “ordinary” distillation) to provide conventional tequila, typically having an alcohol content of about 31% by volume (i.e., about 31% ABV or about 62 proof). Thereafter, the conventional tequila is further distilled (second “rectifying” distillation) to provide a product typically having an alcohol content of about 63% ABV. As shown in FIG. 3, light and heavy cuts from the first ordinary distillation and second rectifying distillation are returned to the must (spent must) from which they arose and further distilled. Once the second rectifying distillation is complete, the resultant product can be proof adjusted to yield lower-proof conventional tequila blanco, e.g., typically having an alcohol content of about 40% ABV. The conventional tequila blanco can optionally be aged to provide conventional tequila reposado, e.g., typically having an alcohol content of about 40% ABV. Alternatively, in another embodiment (not shown), the product from the second rectifying distillation can be proof-adjusted to provide a proof-adjusted product having an alcohol content of about 43%. The proof-adjusted product is the aged and proof adjusted to provide conventional tequila reposado, e.g., typically having an alcohol content of about 40% ABV.

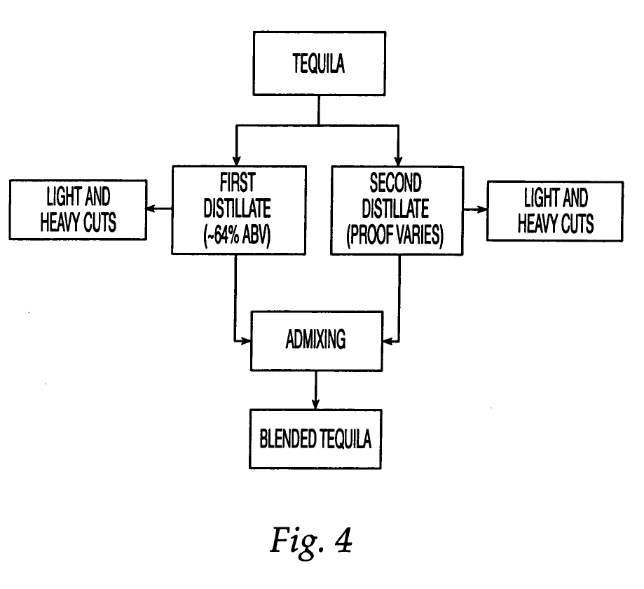

FIG. 4 depicts an embodiment of the invention where a “conventional tequila product,” i.e., conventional tequila, conventional tequila blanco, conventional tequila reposado, conventional tequila ańejo, or any mixture thereof, is divided into two portions that are distilled at least substantially simultaneously. One portion of the conventional tequila product starting material is distilled to provide a first distillate having an alcohol content of about 64% ABV. A second portion of the conventional tequila product starting material is distilled under conditions sufficient to provide a second distillate having a composition different from the first distillate. As shown in FIG. 4, light and heavy cuts obtained during the first and second distillations are removed from the process. Also as shown in FIG. 4, the alcohol content (proof) of the second distillate can vary. The first and second distillates are then blended to provide blended tequila of the invention.

In another embodiment, the two portions of the conventional tequila are distilled simultaneously. In another embodiment, greater than 60% of the second distillate by volume is formed concurrently with the formation of the first distillate from the conventional tequila. In another embodiment, greater than 73% of the second distillate by volume is formed concurrently with the formation of the first distillate from the conventional tequila. In another embodiment, greater than 90% of the second distillate by volume is formed concurrently with the formation of the first distillate from the conventional tequila. In another embodiment, greater than 94% of the second distillate by volume is formed concurrently with the formation of the first distillate from the conventional tequila.

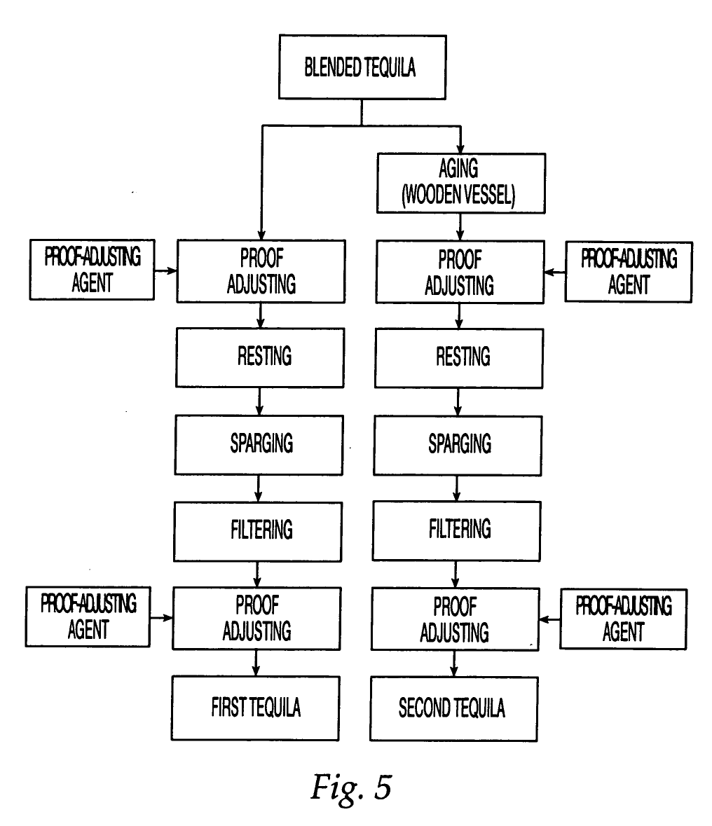

FIG. 5 depicts an embodiment of the invention where blended tequila of the invention is further processed by proof-adjusting, resting, sparging with gas, filtering, and proof-adjusting to provide a first tequila. In an alternate embodiment shown in FIG. 5, the blended tequila of the invention is aged in a wooden vessel then further processed by proof-adjusting, resting, sparging with gas, filtering, and proof-adjusting to provide a second tequila.

### 5.3 Alcoholic Beverages of the Invention

In one embodiment, the present invention relates to an alcoholic beverage prepared by any method of the invention. In another embodiment, the present invention relates to a first blend made by the method of the invention. In another embodiment, the first blend comprises tequila. In another embodiment, the first blend consists essentially of tequila. In another embodiment, the first blend is tequila as exemplified by CORZO® first blend tequila, a product derived from the HEART OF HEARTS PROCESS™ for making an alcoholic beverage. In another embodiment, the present invention relates to an aged second blend made by the method of the invention. In another embodiment, the aged second blend comprises tequila. In another embodiment, the aged second blend consists essentially of tequila. In another embodiment, the aged second blend is tequila as exemplified by CORZO® aged second blend tequila, a product derived from the HEART OF HEARTS PROCESS™ for making an alcoholic beverage.

In one embodiment, the present invention relates to an alcoholic beverage comprising a first blend made by the method of the invention. In another embodiment, the first blend is packaged to provide an alcoholic beverage. In another embodiment, the present invention relates to an alcoholic beverage comprising an aged second blend made by the method of the invention. In another embodiment, the second blend is packaged to provide an alcoholic beverage. In another embodiment, the present invention relates to an alcoholic beverage comprising a combination of a first blend and an aged second blend, each made by the method of the invention. In another embodiment, the combination of a first blend and an aged second blend is packaged to provide an alcoholic beverage.

In one embodiment, the present invention relates to a blended alcoholic beverage comprising a blend of the first blend of the invention and at least one conventional distilled spirit. In the context of a “blended alcoholic beverage,” the term “conventional distilled spirit” is defined according to the distilled spirit definition provided in 27 U.S.C. §211(a), i.e., as ethyl alcohol, hydrated oxide of ethyl, spirits of wine, whiskey, rum, brandy, gin, vodka, and other distilled spirits, including all dilutions and mixtures thereof for nonindustrial use.

In another embodiment, the blended alcoholic beverage contains more of the first blend of the invention by volume than all of the volume of the conventional distilled spirit(s) present in the blended alcoholic beverage. In another embodiment, the blended alcoholic beverage contains from 51% by volume of the first blend of the invention and 49% by volume of all of the conventional distilled spirit(s) present in the blended alcoholic beverage. In another embodiment, the blended alcoholic beverage is formed from up to about 95% by volume of the first blend of the invention. In another embodiment, the blended alcoholic beverage is formed from at least about 5% by volume of the first blend of the invention. In another embodiment, the blended alcoholic beverage is formed from at least about 5% by volume of the first blend of the invention and up to about 95% by volume of all of the conventional distilled spirit(s) present in the blended alcoholic beverage. In another embodiment, the blended alcoholic beverage is formed from at least about 5% by volume of all of the conventional distilled spirit(s) present in the blended alcoholic beverage and up to about 95% by volume of the first blend of the invention.

In another embodiment, the blended alcoholic beverage is formed from up to about 90% by volume of all of the conventional distilled spirit(s) present in the blended alcoholic beverage. In another embodiment, the blended alcoholic beverage is formed from at least about 10% by volume of the first blend of the invention. In another embodiment, the blended alcoholic beverage is formed from at least about 10% by volume of the first blend of the invention and up to about 90% by volume of all of the conventional distilled spirit(s) present in the blended alcoholic beverage. In another embodiment, the blended alcoholic beverage is formed from up to about 90% by volume of the first blend of the invention. In another embodiment, the blended alcoholic beverage is formed from at least about 10% by volume of all of the conventional distilled spirit(s) present in the blended alcoholic beverage and up to about 90% by volume of the first blend of the invention.

In one embodiment, the present invention relates to a blended alcoholic beverage comprising a blend of the aged second blend of the invention and at least one conventional distilled spirit. In another embodiment, the blended alcoholic beverage contains more of the aged second blend of the invention by volume than all of the volume of the conventional distilled spirit(s) present in the blended alcoholic beverage. In another embodiment, the blended alcoholic beverage is formed from 51% by volume of the aged second blend of the invention and 49% by volume of all of the conventional distilled spirit(s) present in the blended alcoholic beverage. In another embodiment, the blended alcoholic beverage is formed from up to about 95% by volume of the aged second blend of the invention. In another embodiment, the blended alcoholic beverage is formed from at least about 5% by volume of the aged second blend of the invention. In another embodiment, the blended alcoholic beverage is formed from at least about 5% by volume of the aged second blend of the invention and up to about 95% by volume of all of the conventional distilled spirit(s) present in the blended alcoholic beverage. In another embodiment, the blended alcoholic beverage is formed from at least about 5% by volume of all of the conventional distilled spirit(s) present in the blended alcoholic beverage and up to about 95% by volume of the aged second blend of the invention.

In another embodiment, the blended alcoholic beverage is formed from up to about 90% by volume of all of the conventional distilled spirit(s) present in the blended alcoholic beverage. In another embodiment, the blended alcoholic beverage is formed from at least about 10% by volume of the aged second blend of the invention. In another embodiment, the blended alcoholic beverage is formed from at least about 10% by volume of the aged second blend of the invention and up to about 90% by volume of all of the conventional distilled spirit(s) present in the blended alcoholic beverage. In another embodiment, the blended alcoholic beverage is formed from up to about 90% by volume of the aged second blend of the invention. In another embodiment, the blended alcoholic beverage is formed from at least about 10% by volume of all of the conventional distilled spirit(s) present in the blended alcoholic beverage and up to about 90% by volume of the aged second blend of the invention.

In one embodiment, the present invention relates to a blended alcoholic beverage comprising a blend of the first blend of the invention and at least one conventional wine. In the context of a “blended alcoholic beverage,” the term “conventional wine” is defined according to the wine definition provided in 27 U.S.C. §211(a), i.e., as (a) wine as defined in §610 and §617 of the Revenue Act of 1918 (26 U.S.C. §§5381-5392), as now in force or hereafter amended, and (b) other alcoholic beverages not so defined, but made in the manner of wine, including sparkling and carbonated wine, wine made from condensed grape must, wine made from other agricultural products than the juice of sound, ripe grapes, imitation wine, compounds sold as wine, vermouth, cider, sherry, and sake; in each instance, only if containing not less than 7% and not more than 24% of ABV, and if for nonindustrial use.

In another embodiment, the blended alcoholic beverage contains more of the first blend of the invention by volume than all of the volume of the conventional wine(s) present in the blended alcoholic beverage. In another embodiment, the blended alcoholic beverage contains from 51% by volume of the first blend of the invention and 49% by volume of all of the conventional wine(s) present in the blended alcoholic beverage. In another embodiment, the blended alcoholic beverage is formed from up to about 95% by volume of the first blend of the invention. In another embodiment, the blended alcoholic beverage is formed from at least about 5% by volume of the first blend of the invention. In another embodiment, the blended alcoholic beverage is formed from at least about 5% by volume of the first blend of the invention and up to about 95% by volume of all of the conventional wine(s) present in the blended alcoholic beverage. In another embodiment, the blended alcoholic beverage is formed from at least about 5% by volume of all of the conventional wine(s) present in the blended alcoholic beverage and up to about 95% by volume of the first blend of the invention.

In another embodiment, the blended alcoholic beverage is formed from up to about 90% by volume of all of the conventional wine(s) present in the blended alcoholic beverage. In another embodiment, the blended alcoholic beverage is formed from at least about 10% by volume of the first blend of the invention. In another embodiment, the blended alcoholic beverage is formed from at least about 10% by volume of the first blend of the invention and up to about 90% by volume of all of the conventional wine(s) present in the blended alcoholic beverage. In another embodiment, the blended alcoholic beverage is formed from up to about 90% by volume of the first blend of the invention. In another embodiment, the blended alcoholic beverage is formed from at least about 10% by volume of all of the conventional wine(s) present in the blended alcoholic beverage and up to about 90% by volume of the first blend of the invention.

In one embodiment, the present invention relates to a blended alcoholic beverage comprising a blend of the aged second blend of the invention and at least one conventional wine. In another embodiment, the blended alcoholic beverage contains more of the aged second blend of the invention by volume than all of the volume of the conventional wine(s) present in the blended alcoholic beverage. In another embodiment, the blended alcoholic beverage is formed from 51% by volume of the aged second blend of the invention and 49% by volume of all of the conventional wine(s) present in the blended alcoholic beverage. In another embodiment, the blended alcoholic beverage is formed from up to about 95% by volume of the aged second blend of the invention. In another embodiment, the blended alcoholic beverage is formed from at least about 5% by volume of the aged second blend of the invention. In another embodiment, the blended alcoholic beverage is formed from at least about 5% by volume of the aged second blend of the invention and about 95% by volume of all of the conventional wine(s) present in the blended alcoholic beverage. In another embodiment, the blended alcoholic beverage is formed from at least about 5% by volume of all of the conventional wine(s) present in the blended alcoholic beverage and up to about 95% by volume of the aged second blend of the invention of the invention.

In another embodiment, the blended alcoholic beverage is formed from up to about 90% by volume of all of the conventional wine(s) present in the blended alcoholic beverage. In another embodiment, the blended alcoholic beverage is formed from at least about 10% by volume of the aged second blend of the invention of the invention and up to about 90% by volume of all of the conventional wine(s) present in the blended alcoholic beverage. In another embodiment, the blended alcoholic beverage is formed from up to about 90% by volume of the aged second blend of the invention of the invention. In another embodiment, the blended alcoholic beverage is formed from at least about 10% by volume of all of the conventional wine(s) present in the blended alcoholic beverage and up to about 90% by volume of the aged second blend of the invention of the invention.

In another embodiment, the first blend of the invention in the blended alcoholic beverage comprises tequila. In another embodiment, the first blend of the invention in the blended alcoholic beverage consists essentially of tequila. In another embodiment, the first blend of the invention in the blended alcoholic beverage is tequila. In each of these embodiments, the conventional distilled spirit in the blended alcoholic beverage comprises a conventional tequila product in one embodiment, consists essentially of a conventional tequila product in another embodiment, and is a conventional tequila product in another embodiment.

In another embodiment, the aged second blend of the invention in the blended alcoholic beverage comprises tequila. In another embodiment, the aged second blend of the invention in the blended alcoholic beverage consists essentially of tequila. In another embodiment, the aged second blend of the invention in the blended alcoholic beverage is tequila. In each of these embodiments, the conventional distilled spirit in the blended alcoholic beverage comprises a conventional tequila product in one embodiment, consists essentially of a conventional tequila product in another embodiment, and is a conventional tequila product in another embodiment.

### 6. EXAMPLES

The following examples are set forth to assist in understanding the invention and should not be construed as specifically limiting the invention described and claimed herein. Such variations of the invention, including the substitution of all equivalents now known or later developed, which would be within the purview of those skilled in the art, and changes in formulation or minor changes in experimental design, are to be considered to fall within the scope of the present invention.

### Example 1

### Process for Making Alcoholic Beverage A

Demineralized water (1200 liters) was added to a 4000 liter distillation pot containing conventional Tequila Cazadores Reposado (2800 liters) (Cazadores, Arandas, Mexico) (a tequila made from 100% of Agave Tequilana Weber and aged for 2 months in an oak barrel) to provide an admixture having an ABV of 30%. The admixture was then distilled at atmospheric pressure (about 1 atm) with a simple overhead takeoff (about 1 theoretical stage). The first 80 liters of distillate (light cut) (from about 78° C. to about 81° C.) was removed from the process, and the next 1700 liters of distillate (Composite A) (from about 81° C. to about 96° C.) was collected.

Demineralized water (1200 liters) was added to a 4000 liter distillation pot containing conventional Tequila Cazadores Reposado (2800 liters) to provide an admixture having an ABV of 30%. The admixture was then distilled at atmospheric pressure (about 1 atm) with a simple overhead takeoff (about 1 theoretical stage), the distillation being carried out at least substantially simultaneously with the distillation of Composite A. The first 130 liters of distillate (light cut) (from about 78° C. to about 83° C.) was removed from the process, and the next 750 liters of distillate (Composite B) (from about 83° C. to about 85° C.) was collected.

Composites A (1700 liters) and B (750 liters) were charged to a stainless steel tank equipped with an agitator and mixed at 25° C. to form a blend having an ABV of 67%. The blend was then diluted with demineralized water (865 liters) until the alcohol content was about 42% ABV and sparged for 9 hours with clean, oil-free compressed air passed through a stainless steel diffuser. The sparged mixture was then filtered through a plate and frame filter equipped with a Supra-50 pad (0.5 μm, 5 m²) (Seitz Filter Werke, Bad Krauznack, Germany). The Supra-50 pad was pre-rinsed with a 0.5% (w/w) aqueous solution of citric acid followed by a water rinse to avoid imparting a paper taste to the finished product. The resultant filtrate was charged to a bottling tank, and a sufficient quantity of demineralized water was added until the contents of the tank had an ABV of 40%. The resultant diluted filtrate was then bottled to provide Alcoholic Beverage A, e.g., CORZO TEQUILA SILVER™ first blend tequila.

### Example 2

### Process for Making Alcoholic Beverage B

Demineralized water (1200 liters) was added to a 4000 liter distillation pot containing conventional Tequila Cazadores Reposado (2800 liters) to provide an admixture having an ABV of 30%. The admixture was then distilled at atmospheric pressure (about 1 atm) with a simple overhead takeoff (about 1 theoretical stage). The first 80 liters of distillate (light cut) (from about 78° C. to about 81° C.) was removed from the process, and the next 1700 liters of distillate (Composite C) (from about 81° C. to about 96° C.) was collected.

Demineralized water (1200 liters) was added to a 4000 liter distillation pot containing conventional Tequila Cazadores Reposado (2800 liters) to provide an admixture having an ABV of 30%. The admixture was then distilled at atmospheric pressure (about 1 atm) with a simple overhead takeoff (about 1 theoretical stage), the distillation being carried out at least substantially simultaneously with the distillation of Composite C. The first 280 liters of distillate (light cut) (from about 78° C. to about 84° C.) was removed from the process, and the next 400 liters of distillate (Composite D) (from about 84° C. to about 88° C.) was collected.

Composites C (1700 liters) and D (400 liters) were charged to a stainless steel tank equipped with an agitator and mixed at 25° C. to form a blend having an ABV of 66.4%. The blend was then diluted with a sufficient amount of demineralized water (about 350 liters) to provide a diluted blend with an ABV of 57%. The diluted blend was then aged in oak barrels (all of which had been used previously to age conventional tequila) for a total of 2 months at about 25° C.; the first 17 days of aging was carried out in lightly charred oak barrels followed by aging in heavily charred oak barrels. The contents of the heavily charred oak barrels were then transferred to a stainless steel tank equipped with an agitator. The contents of the tank were mixed at 25° C., and honey and demineralized water were added in sufficient quantity to provide an admixture having an ABV of about 43% and a honey content of 4 g/liter. The resultant admixture was rested for about 16 hours at 25° C. and sparged for 4.5 hours with clean, oil-free compressed air passed through a stainless steel diffuser. The mixture was then filtered through a plate and frame filter equipped with a Supra-50 pad (0.5 μm, 5 m²) as described in Example 1. The resultant filtrate was charged to a bottling tank, and a sufficient quantity of demineralized water was added until the contents of the tank had an ABV of from 39.85% to 40.05%. The resultant diluted filtrate was then bottled to provide Alcoholic Beverage B, e.g., CORZO TEQUILA REPOSADO™ aged second blend tequila.

### Example 3

### Process for Making Alcoholic Beverage C

Example 2 was repeated except that the diluted blend was aged in oak barrels (used previously to age conventional tequila) for a total of 12 months at about 25° C.; the first 17 days of aging was carried out in lightly charred oak barrels followed by aging in heavily charred oak barrels. Thereafter, the contents of the heavily charred oak barrels were transferred to a stainless steel tank equipped with an agitator. The contents of the tank were mixed at 25° C., and honey and demineralized water were added in sufficient quantity to provide an admixture having an ABV of about 43% and a honey content of 4 g/liter. The resultant admixture was rested for about 16 hours at 25° C. and sparged for 4.5 hours with clean, oil-free compressed air passed through a stainless steel diffuser. The mixture was then filtered through a plate and frame filter equipped with a Supra-50 pad (0.5 μm, 5 m²) as described in Example 1. The resultant filtrate was charged to a bottling tank, and a sufficient quantity of demineralized water was added until the contents of the tank had an ABV of from 39.85% to 40.05%. The resultant diluted filtrate was then bottled to provide Alcoholic Beverage C, e.g., CORZO TEQUILA AŃEJO™ aged second blend tequila.

### Example 4

### Process for Making Alcoholic Beverages D1 and D2

Example 4 describes a process that can be used to prepare an alcoholic beverage where the aging step is carried out only in a heavily charred oak barrel, which is a heavily charred virgin oak barrel (i.e., never used to age an alcoholic mixture) in process 4A and a heavily charred oak barrel which has previously been used to age tequila in process4B. A blend of Composites C (1700 liters) and D (400 liters) having an ABV of about 66% is prepared as described in Example 2. The blend is diluted with demineralized water to provide a diluted blend with an ABV of 57%, then aged for a total of 2 months at about 25° C. in the heavily charred virgin oak barrel of process 4A. The contents of the heavily charred virgin oak barrel are then transferred to a stainless steel tank, proof adjusted with honey and demineralized water, rested, sparged, and filtered as described in Example 2. The resultant filtrate is charged to a bottling tank, and a sufficient quantity of demineralized water is added until the contents of the tank have an ABV of about 40%. The resultant diluted filtrate is then bottled to provide Alcoholic Beverage D1.

Additionally, the diluted blend with an ABV of 57% described above is then aged for a total of 2 months at about 25° C. in the heavily charred oak barrel of process 4B. Thereafter, the contents are transferred to a stainless steel tank and processed according to the procedure described above. The resultant diluted filtrate is then bottled to provide Alcoholic Beverage D2.

### Example 5

### Process for Making Alcoholic Beverages E1-E4

Example 5 describes a process that can be used to prepare an alcoholic beverage where the aging step is carried out in three different oak barrels for at least about twelve months. A blend of Composites A (1700 liters) and B (750 liters) having an ABV of 67% is prepared as described in Example 1. The blend is then diluted with demineralized water until the alcohol content is about 55% ABV to form a diluted blend. The diluted blend is then charged to three different oak barrels for aging: portion 1 (from about 35% up to about 45% of the diluted blend by volume) is added to a lightly charred virgin oak barrel (i.e., never used to age an alcoholic mixture); portion 2 (from about 35% up to about 45% of the diluted blend by volume) is added to a lightly charred oak barrel which has previously been used to age tequila; and portion 3 (from about 15% up to about 25% of the diluted blend by volume) is added to a heavily charred oak barrel, which is a heavily charred virgin oak barrel in process 5A and a heavily charred oak barrel which has previously been used to age tequila in process 5B.

In variation 1, the contents of the barrels are then aged for at least two months at 25° C. After aging, portions 1-3 of 5A are combined in a stainless steel tank equipped with an agitator, and the contents of the tank are mixed at 25° C. Honey and demineralized water are added in sufficient quantity to provide an admixture having an ABV of about 43% and a honey content of from about 4 to about 8 g/liter. The resultant admixture is rested for about 16 hours at 25° C. and sparged with clean, oil-free compressed air passed through a stainless steel diffuser for from about 4.5 to about 9 hours. The mixture is then filtered through a plate and frame filter equipped with a Supra-50 pad (0.5 μm, 5 m²) as described in Example 1. The resultant filtrate is charged to a bottling tank, and an additional quantity of demineralized water is added until the contents of the tank have an ABV of about 40%. The resultant diluted filtrate is then bottled to provide Alcoholic Beverage E1.

Additionally, after aging, portions 1-3 of process 5B are combined and processed according to the procedure described above. The resultant diluted filtrate is then bottled to provide Alcoholic Beverage E2.

In variation 2, the contents of the barrels are then aged for at least twelve months at 25° C. After aging, portions 1-3 of process 5 A in variation 2 are combined and processed according to the procedure described above in connection with variation 1 and process 5A. The resultant diluted filtrate is then bottled to provide Alcoholic Beverage E3.

Additionally, after aging, portions 1-3 of process 5B in variation 2 are combined and processed according to the procedure described above in connection with variation 1 and process 5B. The resultant diluted filtrate is then bottled to provide Alcoholic Beverage E4.

The present invention is not to be limited in scope by the specific embodiments disclosed in the examples which are intended as illustrations of a few aspects of the invention and any embodiments that are functionally equivalent are within the scope of this invention. Indeed, various modifications of the invention in addition to those shown and described herein will become apparent to those skilled in the art and are intended to fall within the scope of the appended claims.

All patents, applications, publications, test methods, literature, and other materials cited above are hereby incorporated herein by reference in their entirety for all purposes.

What is claimed is:

1. A method for making an alcoholic beverage, comprising:
a) providing an alcoholic mixture, optionally aged;
b) distilling a first portion of the alcoholic mixture to provide a first distillate;
c) distilling a second portion of the alcoholic mixture under conditions sufficient to provide a second distillate having a composition different from the first distillate; and
d) admixing at least a portion of the first distillate and at least a portion of the second distillate to make a first blend.

2. The method of claim 1, further comprising distilling the first portion of the alcoholic mixture and the second portion of the alcoholic mixture substantially simultaneously.

3. The method of claim 2, wherein the alcoholic mixture comprises conventional tequila, conventional tequila blanco, conventional tequila reposado, conventional tequila ańejo, or any mixture thereof.

4. The method of claim 2, wherein the alcoholic mixture consists essentially of conventional tequila blanco, conventional tequila reposado, or any mixture thereof.

5. The method of claim 2, further comprising admixing the first blend by an admixing method, wherein the admixing is carried out at a temperature of from about 10° C. to about 40° C.

6. The method of claim 2, further comprising admixing the first blend with a proof-adjusting agent to provide a first proof-adjusted first blend.

7. The method of claim 6, wherein the proof-adjusting agent is a flavorant, honey, demineralized water, an alcoholic mixture, or any combination thereof.

8. The method of claim 6, wherein the proof-adjusting agent is added in an amount sufficient to provide an alcohol content of from about 40% to about 46% based on the total volume of the first proof-adjusted first blend.

9. The method of claim 8, where the proof-adjusting agent is added in an amount sufficient to provide an alcohol content of about 43% based on the total volume of the proof-adjusted first blend.

10. The method of claim 6, further comprising resting the first proof-adjusted first blend to provide a rested first blend, wherein the resting is carried out at a temperature of from about 10° C. to about 40° C.

11. The method of claim 10, further comprising sparging the rested first blend to provide a sparged first blend, wherein the sparging is carried out at a temperature of from about 10° C. to about 40° C.

12. The method of claim 11, wherein the sparging is carried out using air.

13. The method of claim 11, further comprising filtering the rested first blend through a filtering medium to provide a filtered first blend.

14. The method of claim 13, wherein the filtering medium is a cellulose fabric having a mean pore diameter of from about 0.2 μm to about 5 μm.

15. The method of claim 14, wherein the filtering medium further comprises a filter aid, wherein the filter aid is diatomaceous earth, expanded pearlite, cellulosic powder, or any mixture thereof.

16. The method of claim 13, further comprising admixing the filtered first blend with a proof-adjusting agent to provide a second proof-adjusted first blend.

17. The method of claim 16, wherein the proof-adjusting agent is a flavorant, honey, demineralized water, an alcoholic mixture, or any combination thereof.

18. The method of claim 17, wherein the proof-adjusting agent is added in an amount sufficient to provide an alcohol content of from about 35% to about 43% based on the total volume of the second proof-adjusted first blend.

19. The method of claim 18, wherein the proof-adjusting agent is added in an amount sufficient to provide an alcohol content of about 40% based on the total volume of the second proof-adjusted first blend.

20. The method of claim 2, further comprising aging the first blend in a wooden vessel to provide an aged second blend.

21. The method of claim 20, wherein the wooden vessel is a seasoned oak barrel and wherein the aging is carried out at a temperature of from about 10° C. to about 40° C.

22. The method of claim 20, wherein the aging is carried out for a time of from about 2 months to about 10 years.

23. The method of claim 20, further comprising admixing the aged second blend with a proof-adjusting agent to provide a first proof-adjusted second blend.

24. The method of claim 23, wherein the proof-adjusting agent is a flavorant, honey, demineralized water, an alcoholic mixture, or any combination thereof.

25. The method of claim 24, wherein the proof-adjusting agent is added in an amount sufficient to provide an alcohol content of from about 40% to about 46% based on the total volume of the first proof-adjusted second blend.

26. The method of claim 25, wherein the proof-adjusting agent is added in an amount sufficient to provide an alcohol content of about 43% based on the total volume of the first proof-adjusted second blend.

27. The method of claim 23, further comprising resting the first proof-adjusted second blend to provide a rested second blend, wherein the resting is carried out at a temperature of from about 10° C. to about 40° C.

28. The method of claim 27, further comprising sparging the rested second blend to provide a sparged second blend, wherein the sparging is carried out at a temperature of from about 10° C. to about 40° C.

29. The method of claim 28, wherein the sparging is carried out using air.

30. The method of claim 28, further comprising filtering the sparged second blend through a filtering medium to provide a filtered second blend.

31. The method of claim 30, wherein the filtering medium is a cellulose fabric having a mean pore diameter of from about 0.2 μm to about 5 μm.

32. The method of claim 31, wherein the filtering medium further comprises a filter aid, wherein the filter aid is diatomaceous earth, expanded pearlite, cellulosic powder, or any mixture thereof.

33. The method of claim 30, further comprising admixing the filtered second blend with a proof-adjusting agent to provide a second proof-adjusted second blend.

34. The method of claim 33, wherein the proof-adjusting agent is a flavorant, honey, demineralized water, an alcoholic mixture, or any combination thereof.

35. The method of claim 34, wherein the proof-adjusting agent is added in an amount sufficient to provide an alcohol content of from about 38% to about 43% based on the total volume of the second proof-adjusted second blend.

36. The method of claim 35, wherein the proof-adjusting agent is added in an amount sufficient to provide an alcohol content of about 40% based on the total volume of the second proof-adjusted second blend.

37. A method for making an alcoholic beverage, comprising:
a) providing an alcoholic mixture;
b) distilling a first portion of the alcoholic mixture to provide a first distillate;
c) distilling substantially simultaneously a second portion of the alcoholic mixture under conditions sufficient to provide a second distillate having a composition different from the first distillate; and
d) admixing at least a portion of the first distillate and at least a portion of the second distillate to provide a first blend.

38. The method of claim 37, which further comprises:
e) proof-adjusting the sparged first blend to provide a first proof-adjusted first blend having an alcohol content of from about 40% to about 46% alcohol by volume;
f) resting the first proof-adjusted first blend to provide a rested first blend;
g) sparging the rested first blend with air for a time of at least about 9 hours to provide a sparged first blend;
h) filtering the sparged first blend to provide a filtered first blend; and
i) proof-adjusting the filtered first blend to provide a second proof-adjusted first blend having an alcohol content of from about 40% to about 43% alcohol by volume.

39. The method of claim 38, wherein the alcoholic mixture consists essentially of conventional tequila blanco, conventional tequila reposado, or any mixture thereof.

40. The method of claim 37, which further comprises:
e) aging the first blend in a wooden vessel for a time of at least about 2 months to provide an aged second blend;
f) proof-adjusting the aged second blend to provide a first proof-adjusted second blend having an alcohol content of from about 40% to about 46% alcohol by volume;
g) resting the first proof-adjusted second blend to provide a rested second blend;
h) sparging the rested second blend with air for a time of at least abput 4.5 hours to provide a sparged second blend;
i) filtering the sparged second blend to provide a filtered second blend; and
j) proof-adjusting the filtered second blend to provide a second proof-adjusted second blend having an alcohol content of from about 40% to about 43% alcohol by volume.

41. The method of claim 40, wherein the first blend in step (e) is diluted as required to provide a diluted first blend having an alcohol content of from about 50% to about 60% alcohol by volume before carrying out the aging step.

42. The method of claim 40, wherein the alcoholic mixture consists essentially of conventional tequila blanco, conventional tequila reposado, or any mixture thereof.

43. An alcoholic beverage prepared by a method comprising:
a) distilling a first portion of an alcoholic mixture to provide a first distillate;
b) distilling a second portion of the alcoholic mixture under conditions sufficient to provide a second distillate having a composition different from the first distillate; and
c) admixing at least a portion of the first distillate and at least a portion of the second distillate to make a first alcoholic blend.

44. The alcoholic beverage of claim 43, the method further comprising:
d) distilling the first portion of the alcoholic mixture and the second portion of the alcoholic mixture substantially simultaneously.

45. The alcoholic beverage of claim 44, the method further comprising:
e) proof-adjusting the first alcoholic blend to provide a first proof-adjusted first alcoholic blend having an alcohol content of from about 40% to about 46% alcohol by volume;
f) sparging the first proof-adjusted first alcoholic blend to provide a sparged first alcoholic blend;
g) filtering the sparged first alcoholic blend to provide a filtered first alcoholic blend; and
h) proof-adjusting the filtered first alcoholic blend to provide a second proof-adjusted first alcoholic blend having an alcohol content of from about 40% to about 43% alcohol by volume.

46. A blended alcoholic beverage comprising the alcoholic beverage of claim 45 and a conventional distilled spirit.

47. The alcoholic beverage of claim 44, the method further comprising:
e) diluting the first alcoholic blend as required to provide a diluted first alcoholic blend having an alcohol content of from about 50% to about 60% alcohol by volume;
f) aging the diluted first alcoholic blend in a wooden vessel to provide an aged second alcoholic blend;
g) proof-adjusting the aged second alcoholic blend to provide a first proof-adjusted second alcoholic blend having an alcohol content of from about 40% to about 46% alcohol by volume;
h) sparging the first proof-adjusted second alcoholic blend to provide a sparged second alcoholic blend;
i) filtering the sparged second blend to provide a filtered second alcoholic blend; and
j) proof-adjusting the filtered second alcoholic blend to provide a second proof-adjusted second alcoholic blend having an alcohol content of from about 40% to about 43% alcohol by volume.

48. A blended alcoholic beverage comprising the alcoholic beverage of claim 47 and a conventional distilled spirit.

49. A tequila beverage prepared by a method comprising:
a) providing an alcoholic mixture comprising conventional tequila, conventional tequila blanco, conventional tequila reposado, or any mixture thereof;
b) distilling a first portion of the alcoholic mixture to provide a first distillate;
c) distilling a second portion of the alcoholic mixture under conditions sufficient to provide a second distillate having a composition different from the first distillate; and
d) admixing at least a portion of the first distillate and at least a portion of the second distillate to make a first tequila blend.

50. The tequila beverage of claim 49, the method further comprising distilling the first portion of the alcoholic mixture and the second portion of the alcoholic mixture substantially simultaneously.

51. The tequila beverage of claim 50, wherein the alcoholic mixture consists essentially of conventional tequila blanco, conventional tequila reposado, or any mixture thereof.

52. The tequila beverage of claim 50, the method further comprising:
e) proof-adjusting the first tequila blend to provide a first proof-adjusted first tequila blend having an alcohol content of from about 40% to about 46% alcohol by volume;
f) sparging the first proof-adjusted first tequila blend to provide a sparged first tequila blend;
g) filtering the sparged first tequila blend to provide a filtered first tequila blend; and
h) proof-adjusting the filtered first tequila blend to provide a second proof-adjusted first tequila blend having an alcohol content of from about 40% to about 43% alcohol by volume.

53. A blended alcoholic beverage comprising the tequila beverage of claim 52 and a conventional distilled spirit.

54. The tequila beverage of claim 50, the method further comprising:
e) diluting the first tequila blend as required to provide a diluted first tequila blend having an alcohol content of from about 50% to about 60% alcohol by volume;
f) aging the diluted first tequila blend in a wooden vessel to provide an aged second tequila blend;
g) proof-adjusting the aged second tequila blend to provide a first proof-adjusted second tequila blend having an alcohol content of from about 40% to about 46% alcohol by volume;
h) sparging the first proof-adjusted second tequila blend to provide a sparged second tequila blend;
i) filtering the sparged second tequila blend to provide a filtered second tequila blend; and
j) proof-adjusting the filtered second tequila blend to provide a second proof-adjusted second tequila blend having an alcohol content of from about 40% to about 43% alcohol by volume.

55. The tequila beverage of claim 54, wherein step (f) is carried out in a heavily charred oak barrel.

56. The tequila beverage of claim 54, wherein aging step (f) is carried out by dividing the diluted first tequila blend into three portions; wherein
the first portion is aged in a lightly charred virgin oak barrel;
the second portion is aged in a lightly charred oak barrel previously used to age an alcoholic mixture; and
the third portion is aged in a heavily charred oak barrel.

57. The tequila beverage of claim 56, wherein:
the first portion is at least about 35% up to about 45% of the volume of the diluted first tequila blend;
the second portion is at least about 35% up to about 45% of the volume of the diluted first tequila blend; and
the third portion is at least about 15% up to about 25% of the volume of the diluted first tequila blend.

58. A blended alcoholic beverage comprising the tequila beverage of claim 57 and a conventional distilled spirit.

59. An alcoholic beverage comprising a component prepared by the method of claim 2.

60. An alcoholic beverage comprising a component prepared by the method of claim 3.

61. An alcoholic beverage comprising a component prepared by the method of claim 4.

62. An alcoholic beverage comprising a component prepared by the method of claim 8.

63. An alcoholic beverage comprising a component prepared by the method of claim 11.

64. An alcoholic beverage comprising a component prepared by the method of claim 18.

65. An alcoholic beverage comprising a component prepared by the method of claim 20.

66. An alcoholic beverage comprising a component prepared by the method of claim 25.

67. An alcoholic beverage comprising a component prepared by the method of claim 28.

68. An alcoholic beverage comprising a component prepared by the method of claim 35.
